(19) United States
(12) Patent Application Publication
(10) Pub. No.: US 2025/0348731 A1
(43) Pub. Date: Nov. 13, 2025

(54) SYSTEMS AND METHODS FOR FUNCTION-CALLING AGENT MODELS

(71) Applicant: Salesforce, Inc., San Francisco, CA (US)

(72) Inventors: Jianguo Zhang, San Jose, CA (US); Tian Lan, San Francisco, CA (US); Ming Zhu, San Francisco, CA (US); Zuxin Liu, San Francisco, CA (US); Thai Hoang, San Francisco, CA (US); Shirley Kokane, San Francisco, CA (US); Weiran Yao, Mountain View, CA (US); Juntao Tan, San Francisco, CA (US); Shelby Heinecke, San Francisco, CA (US); Zhiwei Liu, Santa Clara, CA (US); Huan Wang, Palo Alto, CA (US)

(21) Appl. No.: 18/973,871

(22) Filed: Dec. 9, 2024

Related U.S. Application Data
(60) Provisional application No. 63/645,692, filed on May 10, 2024.
(60) Provisional application No. 63/660,512, filed on Jun. 15, 2024.

(51) Int. Cl. G06N 3/08; G06F 9/54

(52) U.S. Cl. CPC G06N 3/08; G06F 9/54

(57) ABSTRACT

Embodiments described herein provide a method of generating a response to a user prompt by a function-calling artificial intelligence (AI) agent. The method comprises generating, via an LLM based on a prompt template, a training pair including a generated prompt and a first executable function call; including or excluding the training pair in a training dataset depending on a validation decision of the training pair; training the function-calling AI agent based on the training dataset; generating, by the function-calling AI agent, a second executable function call based on the user prompt; and executing the second executable function call via local execution on the one or more processors or via API call to a system remote from the one or more processors, wherein the response to the user prompt is based on a result of the executing the second executable function call.

### CROSS REFERENCE(S)

The instant application is a nonprovisional of and claim priority under 35 U.S.C. 119 to U.S. provisional application No. 63/645,692, filed May 10, 2024, and U.S. provisional application No. 63/660,512, filed Jun. 15, 2024, which are hereby expressly incorporated by reference herein in their entirety.

### TECHNICAL FIELD

The embodiments relate generally to machine learning systems for function-calling agents, and more specifically to training and fine-tuning function calling agent models.

### BACKGROUND

Machine learning systems have been widely used in creating agents. The advancement of function-calling agent models requires diverse, reliable, and high-quality datasets. However, current datasets are often static, limited in scope, and not verified by execution, leading to potential inaccuracies and inefficiencies in model training. Therefore, there is a need for improved systems and method for function-calling agent models.

### BRIEF DESCRIPTION OF THE DRAWINGS

FIG. 1 is a simplified diagram illustrating a training data generation framework according to some embodiments.

FIG. 2A is a simplified diagram illustrating a computing device implementing the training and data generation described in FIG. 1 and other embodiments described herein.

FIG. 2B is a simplified diagram illustrating a neural network structure, according to some embodiments.

FIG. 3 is a simplified block diagram of a networked system suitable for implementing the training and data generation embodiments described herein.

FIG. 4 is an example logic flow diagram illustrating a method of training a neural network based agent based on the framework shown in FIGS. 1-3, according to some embodiments.

FIG. 5 illustrates exemplary data formats, according to some embodiments.

FIG. 6 is a chart illustrating performance results of embodiments described herein.

FIG. 7 illustrates a data generation pipeline, according to some embodiments.

FIG. 8 illustrates an exemplary unified function calling data format, according to some embodiments.

Embodiments of the disclosure and their advantages are best understood by referring to the detailed description that follows. It should be appreciated that like reference numerals are used to identify like elements illustrated in one or more of the figures, wherein showings therein are for purposes of illustrating embodiments of the disclosure and not for purposes of limiting the same.

### DETAILED DESCRIPTION

As used herein, the term “network” may comprise any hardware or software-based framework that includes any artificial intelligence network or system, neural network or system and/or any training or learning models implemented thereon or therewith.

As used herein, the term “module” may comprise hardware or software-based framework that performs one or more functions. In some embodiments, the module may be implemented on one or more neural networks.

As used herein, the term “Large Language Model” (LLM) may refer to a neural network based deep learning system designed to understand and generate human languages. An LLM may adopt a Transformer architecture that often entails a significant amount of parameters (neural network weights) and computational complexity. For example, LLM such as Generative Pre-trained Transformer (GPT) 3 has 175 billion parameters, Text-to-Text Transfer Transformers (T5) has around 11 billion parameters.

### Overview

The advancement of function-calling agent models requires diverse, reliable, and high-quality datasets. However, current datasets are often static, limited in scope, and not verified by execution, leading to potential inaccuracies and inefficiencies in model training.

In view of the need for improved systems and method for function-calling agent models, embodiments described herein provide automatic data generation and training methods. As described herein, APIGen is an automated data generation pipeline designed to produce verifiable high-quality datasets for function-calling applications. APIGen leverages existing Python API libraries and structured example data to generate potentially infinite and diverse function-calling datasets. Each data may be verified through three hierarchical stages: format checking, actual function executions, and semantic verification, ensuring the dataset's reliability and correctness. Experiments demonstrate APIGen's effectiveness in generating diverse, high-quality datasets from various Python APIs and filtering out low-quality data through its robust multi-stage verification process. Training of function-calling agent models based on the generated dataset results in improved model performance. Examples herein are described with reference to Python APIs, but embodiments described herein may be applied to various programming languages with various API or API-like interfaces.

Embodiments described herein provide a number of benefits. For example, by executing each API call, the system ensures the accuracy of query-answer pairs, critical for training reliable function-calling agents. APIGen is designed to expand across multiple libraries and frameworks, adapting to new Python APIs for large-scale dataset generation. Further, the datasets generated by APIGen are designed to be diverse and mimic realistic situations, resulting in more robust agent performance. This is achieved by varying prompt templates and employing random sampling during the data generation process. Therefore, neural network technology in function-calling agent models is improved.

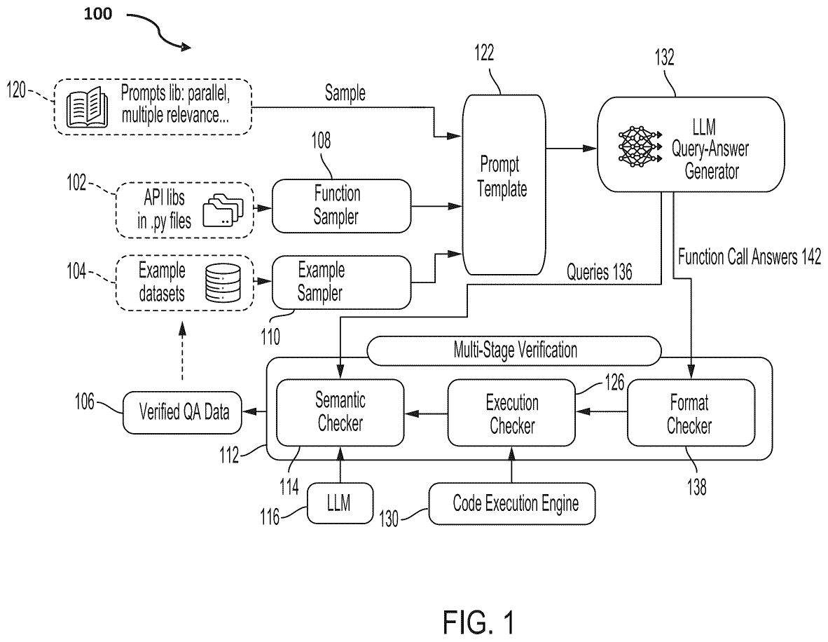

FIG. 1 is a simplified diagram illustrating a training data generation framework 100 according to some embodiments. The framework 100 may be utilized in synthesizing training data for function-calling LLM agents, including queries and known-good function calls. By validating generated function calls, the dataset is high enough quality to train a reliable function-calling LLM agent. By diversifying the synthesized data, training may avoid overfitting to a small amount of narrowly defined training data.

Framework 100 includes an LLM 132 that generates query/answer pairs. In some embodiments, the generated function call answer 142 is a function call. For example, a function call in some programming language. In some embodiments, the function call answer 142 is an API call to a remote service. Queries 136 and/or function call answers 142 may be generated by LLM query-answer generator based on an a prompt. The prompt may include a fixed portion (e.g., a “system” prompt) that describes the task to be performed by the query-answer generator. The system prompt may be set via prompt template 122. Prompt template 122. The prompt may include example function definitions. For example, API and/or programming language function call libraries 102 may be sampled via function sampler 108. The use of function sampler 108 may allow for diversity in the example functions provided in the prompt to LLM query-answer generator 132. Similarly, example query-answer training data from example dataset 104 may be sampled via example sampler 110. As with function sampler 108, example query-answer sampler may be used to increase the diversity of examples provided. In some embodiments, the prompt itself may be varied by sampling from a prompt library 120. In some embodiments, the example sampler 110 may sample n examples from pre-loaded data from multiple sources and transform each into structured information, including queries, tools, and answers. This provides an example dataset for generating queries and corresponding function calls.

Query style may be diversified in a number of ways. The prompt library 120 may be structured into multiple categories, including simple, multiple, parallel, and parallel multiple, each designed to challenge and enhance the model's capabilities in different usage scenarios. Simple query style includes straightforward scenarios where a single function call is made based on the user's input with a single provided JSON format API description. Multiple query style queries could be answered by one of several function calls. The challenge lies in selecting the most appropriate function from multiple provided APIs. It represents one of the most common real-world use cases. Parallel query style requires executing multiple function calls simultaneously in response to a single user query, which may consist of one or more sentences but with only one API provided. For instance, if the user wants to know the weather in both Palo Alto and Paris, the model should call the get_weather function twice with corresponding city names in a single response. Parallel multiple query style combines the parallel and multiple categories, where multiple function and API documents are provided, and each function call might be invoked multiple times based on the query's requirements. Each of the query styles may be generated by LLM 132 by different prompts as included in prompt library 120.

Sampling diversity may be further achieved via function sampler 108, example sampler 110, and/or a prompt sampler for sampling from prompt library 120. Function sampler 108 may extract one or more function descriptions from executable library 102, standardizing them into a uniform JSON format. The diverse sources of APIs ensure a wide range of function calls are available for inclusion in the training dataset. Example sampler 110 may sample a specified number of seed examples 104 corresponding to the different categories (e.g., simple, multiple, parallel, and parallel multiple). These examples are transformed into structured queries, function descriptions, and answers, serving as an important reference for data generation. A prompt sampler may sample from a diverse prompt library 120 to generate a variety of query-answer pairs. The prompts for each query style contain different contexts, ranging from simple, concise query-answer pairs to more realistic scenarios, such as ambiguous or misspelled user requests, enhancing the model's ability to handle real-world interactions.

Generated queries 136 and function call answers 142 may be validated via a multi-stage verification process 112 to ensure that the data which may be used in subsequent training is of high quality. In some embodiments, multi-stage verification process 112 includes a format checker 138, execution checker 126, and/or semantic checker 114. The output of multi-stage verification process 112 is verified QA data 106. The verified QA data 106 may be used to augment example datasets 104. This may be used in training other models, or may be used to as examples within the loop illustrated to generate additional verified QA data via an iterative process.

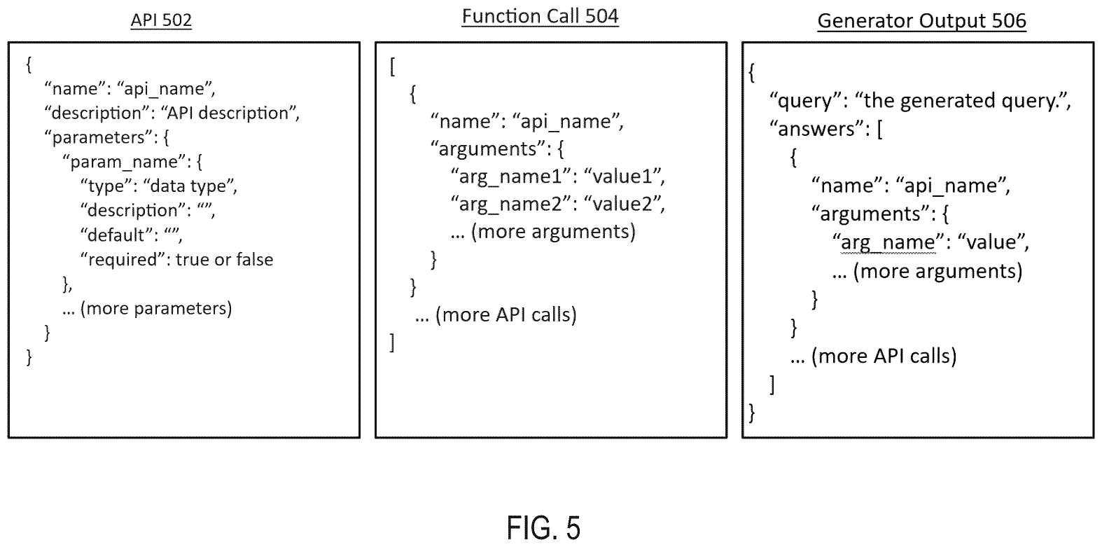

In some embodiments, the input to the system mimics Python docstrings, which provide a clear, structured template for API functions. This approach allows the LLM query-answer generator 132 to precisely understand the required inputs and expected outputs. This structured input helps the LLM 132 accurately generate responses that are expected from the APIs. For outputs, the LLM 132 may be instructed to strictly generate responses in JSON format (e.g., as described in FIG. 5). This format allows for straightforward extraction of key fields and application of format fixers to correct errors that may arise during generation. This process not only enhances success rates but also helps in the early identification of non-useful responses, which are discarded in the initial format-checking stage.

In some embodiments, format checker 138 may perform sanity checks to filter out poorly formatted or incomplete data. In some embodiments, the LLM 132 output must strictly follow a JSON format with the “query” and “answer” fields, as shown in FIG. 5. In some embodiments, an additional “thought” field is included, which is known as the chain-of-thought (CoT) prompting technique, to increase the pass rate of the generated data. The data is discarded if these fields cannot be properly extracted for function calls. Additionally, the function calls may be checked for correct JSON parsing and valid arguments. Generated calls whose arguments or functions are not present in the given APIs are eliminated to reduce hallucination and improve data quality.

Execution checker 126 may execute the Python function calls via code execution engine 130 with an optional timeout and capture the results and outputs. Well-formatted function calls (i.e., those that pass format checker 138) are executed against the appropriate backend (e.g. Python functions are directly imported and executed in a separate subprocess, while REST APIs are called to obtain results and status codes). Unsuccessful executions may be filtered out at this stage. For failed executions, fine-grained error messages may be provided, including argument type errors, invalid parameters, runtime errors, syntax errors, undefined function names or arguments, etc.

A semantic checker 114 may send the query, functions, and execution results to an LLM 116 to check whether the results semantically align with the query objective. This filters out query-answer pairs that execute successfully but do not produce meaningful results due to infeasible queries or incorrect arguments. Query-answer pairs that execute successfully but produce meaningless results due to infeasible queries or incorrect arguments are filtered out. The main decision factors for this stage may include: 1) whether the function call aligns with the objective of query 136 and has proper arguments; 2) whether the function call 142 and arguments of function call 142 are appropriately chosen from the available functions; 3) whether the number of function calls matches the user's intent; 4) whether the execution results contain errors or indicate unsuccessful function execution; 5) whether the execution results are relevant and match the query's purpose. In some embodiments, one or multiple LLMs may be selected as checkers, and the filtering rules can be readily adjusted-either tightened or relaxed—depending on specific use cases.

Verified Question-answer (QA) data 106 may be used in training a function-calling agent model. For example, a neural network based model may be trained by providing the verified inputs, comparing the generated output of the model to the verified answer. In some embodiments, the queries of the verified QA data 106 may include natural language queries and/or formatted API calls (e.g., Python function calls). Training of an agent model based on query-answer pairs may be performed using the queries as a user input, or as part of a user input, and answers as the ground-truth output or part of the ground-truth output (or intermediate output, for example the output of an intermediate step performed by an agent model).

### Computer and Network Environment

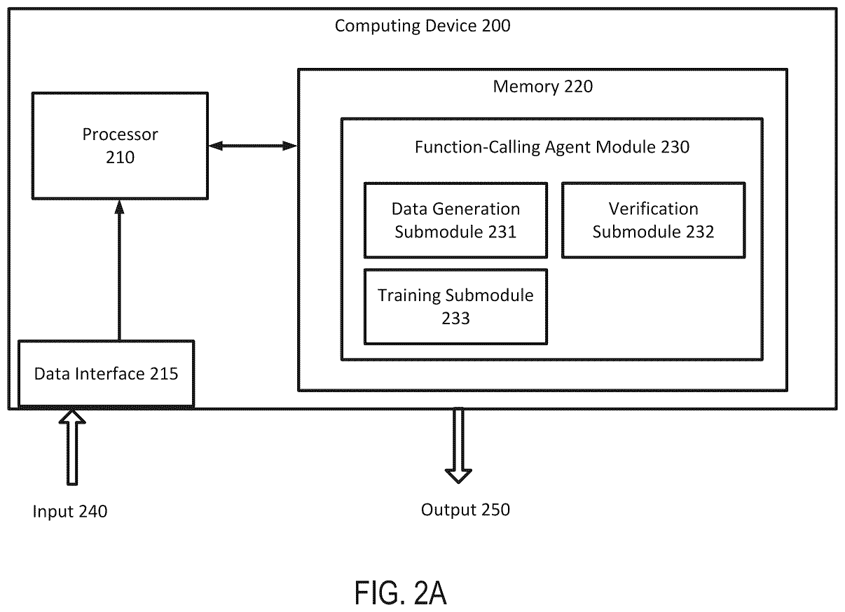

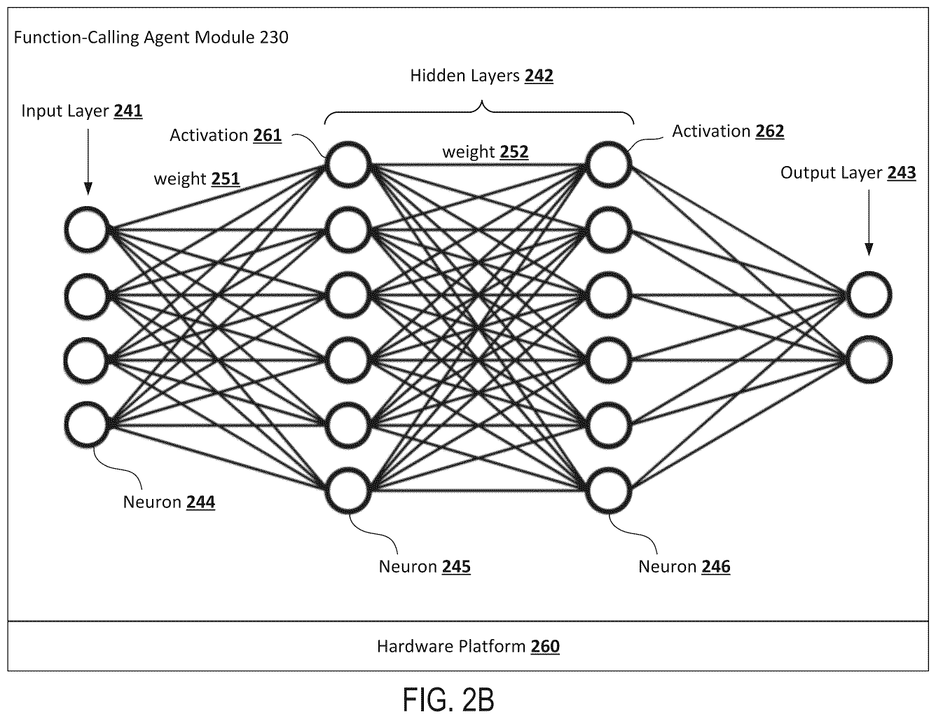

FIG. 2A is a simplified diagram illustrating a computing device implementing the training and data generation described in FIG. 1, according to one embodiment described herein. As shown in FIG. 2A, computing device 200 includes a processor 210 coupled to memory 220. Operation of computing device 200 is controlled by processor 210. And although computing device 200 is shown with only one processor 210, it is understood that processor 210 may be representative of one or more central processing units, multi-core processors, microprocessors, microcontrollers, digital signal processors, field programmable gate arrays (FPGAs), application specific integrated circuits (ASICs), graphics processing units (GPUs) and/or the like in computing device 200. Computing device 200 may be implemented as a stand-alone subsystem, as a board added to a computing device, and/or as a virtual machine.

Memory 220 may be used to store software executed by computing device 200 and/or one or more data structures used during operation of computing device 200. Memory 220 may include one or more types of machine-readable media. Some common forms of machine-readable media may include floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

Processor 210 and/or memory 220 may be arranged in any suitable physical arrangement. In some embodiments, processor 210 and/or memory 220 may be implemented on a same board, in a same package (e.g., system-in-package), on a same chip (e.g., system-on-chip), and/or the like. In some embodiments, processor 210 and/or memory 220 may include distributed, virtualized, and/or containerized computing resources. Consistent with such embodiments, processor 210 and/or memory 220 may be located in one or more data centers and/or cloud computing facilities.

In some examples, memory 220 may include non-transitory, tangible, machine readable media that includes executable code that when run by one or more processors (e.g., processor 210) may cause the one or more processors to perform the methods described in further detail herein. For example, as shown, memory 220 includes instructions for function calling agent module 230 that may be used to implement and/or emulate the systems and models, and/or to implement any of the methods described further herein. function calling agent module 230 may receive input 240 such as an input training data (e.g., API functions, queries, and/or responses) via the data interface 215 and generate an output 250 which may be an action such as an API function call.

The data interface 215 may comprise a communication interface, a user interface (such as a voice input interface, a graphical user interface, and/or the like). For example, the computing device 200 may receive the input 240 (such as a training dataset) from a networked database via a communication interface. Or the computing device 200 may receive the input 240, such as a prompt, from a user via the user interface.

In some embodiments, the function-calling agent module 230 is configured to generate query and answer data associated with an API and/or train a function-calling agent model as described herein. The function-calling agent module 230 may further include data generation submodule 231 (e.g., similar to LLM query-answer generator 132). Data generation submodule 231 may be configured to generate query-answer pairs as described herein in FIG. 1.

The function-calling agent module 230 may further include verification submodule 232 (e.g., similar to multi-stage data verification 112). Verification submodule 232 may be configured to verify query-answer pairs as described in FIG. 1.

The function-calling agent module 230 may further include training submodule 233. Training submodule 233 may be configured to train a function-calling agent model, for example using the generated query-answer pairs, as described herein.

Some examples of computing devices, such as computing device 200 may include non-transitory, tangible, machine readable media that include executable code that when run by one or more processors (e.g., processor 210) may cause the one or more processors to perform the processes of method. Some common forms of machine-readable media that may include the processes of method are, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

FIG. 2B is a simplified diagram illustrating the neural network structure implementing the function calling agent module 230 described in FIG. 2A, according to some embodiments. In some embodiments, the function calling agent module 230 and/or one or more of its submodules 231-233 may be implemented at least partially via an artificial neural network structure shown in FIG. 2B. The neural network comprises a computing system that is built on a collection of connected units or nodes, referred to as neurons (e.g., 244, 245, 246). Neurons are often connected by edges, and an adjustable weight (e.g., 251, 252) is often associated with the edge. The neurons are often aggregated into layers such that different layers may perform different transformations on the respective input and output transformed input data onto the next layer.

For example, the neural network architecture may comprise an input layer 241, one or more hidden layers 242 and an output layer 243. Each layer may comprise a plurality of neurons, and neurons between layers are interconnected according to a specific topology of the neural network topology. The input layer 241 receives the input data (e.g., 240 in FIG. 2A), such as API libraries, example datasets, generated datasets, prompts, etc. The number of nodes (neurons) in the input layer 241 may be determined by the dimensionality of the input data. Each node in the input layer represents a feature or attribute of the input.

The hidden layers 242 are intermediate layers between the input and output layers of a neural network. It is noted that two hidden layers 242 are shown in FIG. 2B for illustrative purpose only, and any number of hidden layers may be utilized in a neural network structure. Hidden layers 242 may extract and transform the input data through a series of weighted computations and activation functions.

For example, as discussed in FIG. 2A, the function calling agent module 230 receives an input 240 of API libraries, example datasets, generated datasets, prompts, etc. and transforms the input into an output 250 of function calls, actions, generated answer-query pairs, etc. To perform the transformation, each neuron receives input signals, performs a weighted sum of the inputs according to weights assigned to each connection (e.g., 251, 252), and then applies an activation function (e.g., 261, 262, etc.) associated with the respective neuron to the result. The output of the activation function is passed to the next layer of neurons or serves as the final output of the network. The activation function may be the same or different across different layers. Example activation functions include but not limited to Sigmoid, hyperbolic tangent, Rectified Linear Unit (ReLU), Leaky ReLU, Softmax, and/or the like. In this way, after a number of hidden layers, input data received at the input layer 241 is transformed into rather different values indicative data characteristics corresponding to a task that the neural network structure has been designed to perform.

The output layer 243 is the final layer of the neural network structure. It produces the network's output or prediction based on the computations performed in the preceding layers (e.g., 241, 242). The number of nodes in the output layer depends on the nature of the task being addressed. For example, in a binary classification problem, the output layer may consist of a single node representing the probability of belonging to one class. In a multi-class classification problem, the output layer may have multiple nodes, each representing the probability of belonging to a specific class.

Therefore, the function calling agent module 230 and/or one or more of its submodules 231-233 may comprise the transformative neural network structure of layers of neurons, and weights and activation functions describing the non-linear transformation at each neuron. Such a neural network structure is often implemented on one or more hardware processors 210, such as a graphics processing unit (GPU).

In one embodiment, the function calling agent module 230 and its submodules 231-233 may comprise one or more LLMs built upon a Transformer architecture. For example, the Transformer architecture comprises multiple layers, each consisting of self-attention and feedforward neural networks. The self-attention layer transforms a set of input tokens (such as words) into different weights assigned to each token, capturing dependencies and relationships among tokens. The feedforward layers then transform the input tokens, based on the attention weights, represents a high-dimensional embedding of the tokens, capturing various linguistic features and relationships among the tokens. The self-attention and feed-forward operations are iteratively performed through multiple layers of self-attention and feedforward layers, thereby generating an output based on the context of the input tokens. One forward pass for an input tokens to be processed through the multiple layers to generate an output in a Transformer architecture often entail hundreds of teraflops (trillions of floating-point operations) of computation.

In one embodiment, the function calling agent module 230 and its submodules 231-233 may be implemented by hardware, software and/or a combination thereof. For example, the function calling agent module 230 and its submodules 231-233 may comprise a specific neural network structure implemented and run on various hardware platforms 260, such as but not limited to CPUs (central processing units), GPUs (graphics processing units), FPGAs (field-programmable gate arrays), Application-Specific Integrated Circuits (ASICs), dedicated AI accelerators like TPUs (tensor processing units), and specialized hardware accelerators designed specifically for the neural network computations described herein, and/or the like. Example specific hardware for neural network structures may include, but not limited to Google Edge TPU, Deep Learning Accelerator (DLA), NVIDIA AI-focused GPUs, and/or the like. The hardware 260 used to implement the neural network structure is specifically configured based on factors such as the complexity of the neural network, the scale of the tasks (e.g., training time, input data scale, size of training dataset, etc.), and the desired performance.

In one embodiment, the neural network based function calling agent module 230 and one or more of its submodules 231-233 may be trained by iteratively updating the underlying parameters (e.g., weights 251, 252, etc., bias parameters and/or coefficients in the activation functions 261, 262 associated with neurons) of the neural network based on a loss function. For example, during forward propagation, the training data such as query-answer pairs are fed into the neural network. The data flows through the network's layers 241, 242, with each layer performing computations based on its weights, biases, and activation functions until the output layer 243 produces the network's output 250. In some embodiments, output layer 243 produces an intermediate output on which the network's output 250 is based.

The output generated by the output layer 243 is compared to the expected output (e.g., a “ground-truth” such as the corresponding answer) from the training data, to compute a loss function that measures the discrepancy between the predicted output and the expected output. Given the loss, the negative gradient of the loss function is computed with respect to each weight of each layer individually. Such negative gradient is computed one layer at a time, iteratively backward from the last layer 243 to the input layer 241 of the neural network. These gradients quantify the sensitivity of the network's output to changes in the parameters. The chain rule of calculus is applied to efficiently calculate these gradients by propagating the gradients backward from the output layer 243 to the input layer 241.

In one embodiment, the neural network based function calling agent module 230 and one or more of its submodules 231-233 may be trained using policy gradient methods, also referred to as “reinforcement learning” methods. For example, instead of computing a loss based on a training output generated via a forward propagation of training data, the “policy” of the neural network model, which is a mapping from an input of the current states or observations of an environment the neural network model is operated at, to an output of action. Specifically, at each time step, a reward is allocated to an output of action generated by the neural network model. The gradients of the expected cumulative reward with respect to the neural network parameters are estimated based on the output of action, the current states of observations of the environment, and/or the like. These gradients guide the update of the policy parameters using gradient descent methods like stochastic gradient descent (SGD) or Adam. In this way, as the “policy” parameters of the neural network model may be iteratively updated while generating an output action as time progresses, the boundaries between training and inference are often less distinct compared to supervised learning—in other words, backward propagation and forward propagation may occur for both “training” and “inference” stages of the neural network mode.

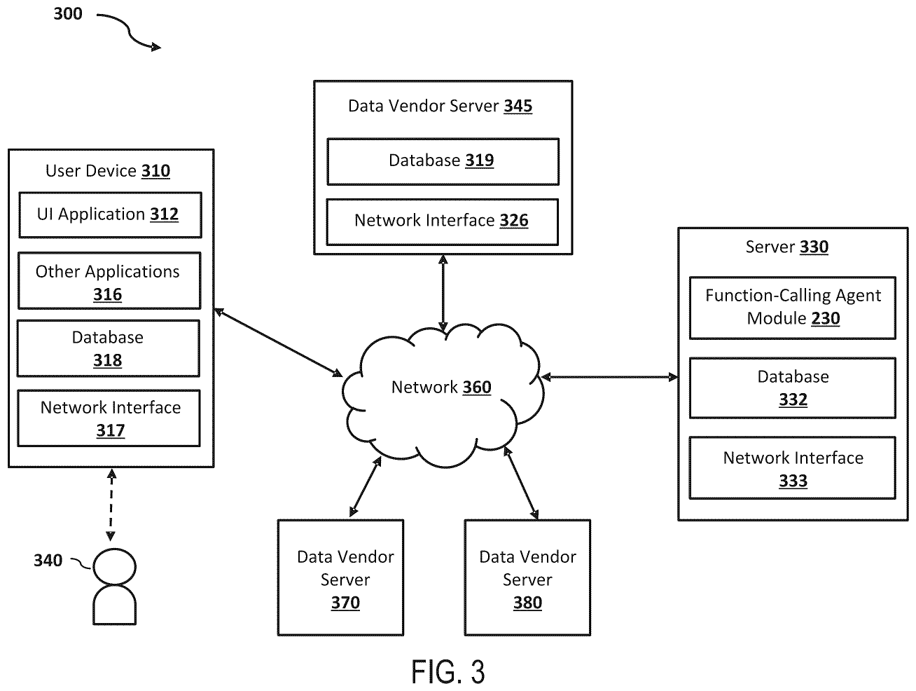

In one embodiment, function calling agent module 230 and its submodules 231-233 may be housed at a centralized server (e.g., computing device 200) or one or more distributed servers. For example, one or more of function calling agent module 230 and its submodules 231-233 may be housed at external server(s). The different modules may be communicatively coupled by building one or more connections through application programming interfaces (APIs) for each respective module. Additional network environment for the distributed servers hosting different modules and/or submodules may be discussed in FIG. 3.

During a backward pass, parameters of the neural network are updated backwardly from the last layer to the input layer (backpropagating) based on the computed negative gradient using an optimization algorithm to minimize the loss. The backpropagation from the last layer 243 to the input layer 241 may be conducted for a number of training samples in a number of iterative training epochs. In this way, parameters of the neural network may be gradually updated in a direction to result in a lesser or minimized loss, indicating the neural network has been trained to generate a predicted output value closer to the target output value with improved prediction accuracy. Training may continue until a stopping criterion is met, such as reaching a maximum number of epochs or achieving satisfactory performance on the validation data. At this point, the trained network can be used to make predictions on new, unseen data, such as selecting next actions based on unseen inputs.

Neural network parameters may be trained over multiple stages. For example, initial training (e.g., pre-training) may be performed on one set of training data, and then an additional training stage (e.g., fine-tuning) may be performed using a different set of training data. In some embodiments, all or a portion of parameters of one or more neural-network model being used together may be frozen, such that the “frozen” parameters are not updated during that training phase. This may allow, for example, a smaller subset of the parameters to be trained without the computing cost of updating all of the parameters.

In some implementations, to improve the computational efficiency of training a neural network model, “training” a neural network model such as an LLM may sometimes be carried out by updating the input prompt, e.g., the instruction to teach an LLM how to perform a certain task. For example, while the parameters of the LLM may be frozen, a set of tunable prompt parameters and/or embeddings that are usually appended to an input to the LLM may be updated based on a training loss during a backward pass. For another example, instead of tuning any parameter during a backward pass, input prompts, instructions, or input formats may be updated to influence their output or behavior. Such prompt designs may range from simple keyword prompts to more sophisticated templates or examples tailored to specific tasks or domains.

In general, the training and/or finetuning of an LLM can be computationally extensive. For example, GPT-3 has 175 billion parameters, and a single forward pass using an input of a short sequence can involve hundreds of teraflops (trillions of floating-point operations) of computation. Training such a model requires immense computational resources, including powerful GPUs or TPUs and significant memory capacity. Additionally, during training, multiple forward and backward passes through the network are performed for each batch of data (e.g., thousands of training samples), further adding to the computational load.

FIG. 3 is a simplified block diagram of a networked system 300 suitable for implementing the training and data generation embodiments described in FIGS. 1-2 and other embodiments described herein. In one embodiment, system 300 includes the user device 310 which may be operated by user 340, data vendor servers 345, 370 and 380, server 330, and other forms of devices, servers, and/or software components that operate to perform various methodologies in accordance with the described embodiments. Exemplary devices and servers may include device, stand-alone, and enterprise-class servers which may be similar to the computing device 200 described in FIG. 2A, operating an OS such as a MICROSOFT® OS, a UNIX® OS, a LINUX® OS, or other suitable device and/or server-based OS. It can be appreciated that the devices and/or servers illustrated in FIG. 3 may be deployed in other ways and that the operations performed, and/or the services provided by such devices and/or servers may be combined or separated for a given embodiment and may be performed by a greater number or fewer number of devices and/or servers. One or more devices and/or servers may be operated and/or maintained by the same or different entities.

The user device 310, data vendor servers 345, 370 and 380, and the server 330 may communicate with each other over a network 360. User device 310 may be utilized by a user 340 (e.g., a driver, a system admin, etc.) to access the various features available for user device 310, which may include processes and/or applications associated with the server 330 to receive an output data anomaly report.

User device 310, data vendor server 345, and the server 330 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 300, and/or accessible over network 360.

User device 310 may be implemented as a communication device that may utilize appropriate hardware and software configured for wired and/or wireless communication with data vendor server 345 and/or the server 330. For example, in one embodiment, user device 310 may be implemented as an autonomous driving vehicle, a personal computer (PC), a smart phone, laptop/tablet computer, wristwatch with appropriate computer hardware resources, eyeglasses with appropriate computer hardware (e.g., GOOGLE GLASS®), other type of wearable computing device, implantable communication devices, and/or other types of computing devices capable of transmitting and/or receiving data, such as an IPAD® from APPLE®. Although only one communication device is shown, a plurality of communication devices may function similarly.

User device 310 of FIG. 3 contains a user interface (UI) application 312, and/or other applications 316, which may correspond to executable processes, procedures, and/or applications with associated hardware. For example, the user device 310 may receive a message indicating a generated dataset, and agent action, or the result of an agent action from the server 330 and display the message via the UI application 312. In other embodiments, user device 310 may include additional or different modules having specialized hardware and/or software as required.

In one embodiment, UI application 312 may communicatively and interactively generate a UI for an AI agent implemented through the function calling agent module 230 (e.g., an LLM agent) at server 330. In at least one embodiment, a user operating user device 310 may enter a user utterance, e.g., via text or audio input, such as a question, uploading a document, and/or the like via the UI application 312. Such user utterance may be sent to server 330, at which function calling agent module 230 may generate a response via the process described in FIGS. 1-2 and other embodiments described herein. The function calling agent module 230 may thus cause a display of actions or the results of actions, etc. at UI application 312 and interactively update the display in real time with the user utterance.

In various embodiments, user device 310 includes other applications 316 as may be desired in particular embodiments to provide features to user device 310. For example, other applications 316 may include security applications for implementing client-side security features, programmatic client applications for interfacing with appropriate application programming interfaces (APIs) over network 360, or other types of applications. Other applications 316 may also include communication applications, such as email, texting, voice, social networking, and IM applications that allow a user to send and receive emails, calls, texts, and other notifications through network 360. For example, the other application 316 may be an email or instant messaging application that receives a prediction result message from the server 330. Other applications 316 may include device interfaces and other display modules that may receive input and/or output information. For example, other applications 316 may contain software programs for asset management, executable by a processor, including a graphical user interface (GUI) configured to provide an interface to the user 340 to view responses.

User device 310 may further include database 318 stored in a transitory and/or non-transitory memory of user device 310, which may store various applications and data and be utilized during execution of various modules of user device 310. Database 318 may store user profile relating to the user 340, predictions previously viewed or saved by the user 340, historical data received from the server 330, and/or the like. In some embodiments, database 318 may be local to user device 310. However, in other embodiments, database 318 may be external to user device 310 and accessible by user device 310, including cloud storage systems and/or databases that are accessible over network 360.

User device 310 includes at least one network interface component 317 adapted to communicate with data vendor server 345 and/or the server 330. In various embodiments, network interface component 317 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Data vendor server 345 may correspond to a server that hosts database 319 to provide training datasets including query-answer pairs to the server 330. The database 319 may be implemented by one or more relational database, distributed databases, cloud databases, and/or the like.

The data vendor server 345 includes at least one network interface component 326 adapted to communicate with user device 310 and/or the server 330. In various embodiments, network interface component 326 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices. For example, in one implementation, the data vendor server 345 may send asset information from the database 319, via the network interface 326, to the server 330.

The server 330 may be housed with the function calling agent module 230 and its submodules described in FIG. 2A. In some implementations, function calling agent module 230 may receive data from database 319 at the data vendor server 345 via the network 360 to generate query-answer pairs, agent actions, or results of agent actions. The generated results may also be sent to the user device 310 for review by the user 340 via the network 360.

The database 332 may be stored in a transitory and/or non-transitory memory of the server 330. In one implementation, the database 332 may store data obtained from the data vendor server 345. In one implementation, the database 332 may store parameters of the function calling agent module 230. In one implementation, the database 332 may store previously generated responses, and the corresponding input feature vectors.

In some embodiments, database 332 may be local to the server 330. However, in other embodiments, database 332 may be external to the server 330 and accessible by the server 330, including cloud storage systems and/or databases that are accessible over network 360.

The server 330 includes at least one network interface component 333 adapted to communicate with user device 310 and/or data vendor servers 345, 370 or 380 over network 360. In various embodiments, network interface component 333 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Network 360 may be implemented as a single network or a combination of multiple networks. For example, in various embodiments, network 360 may include the Internet or one or more intranets, landline networks, wireless networks, and/or other appropriate types of networks. Thus, network 360 may correspond to small scale communication networks, such as a private or local area network, or a larger scale network, such as a wide area network or the Internet, accessible by the various components of system 300.

### Example Work Flows

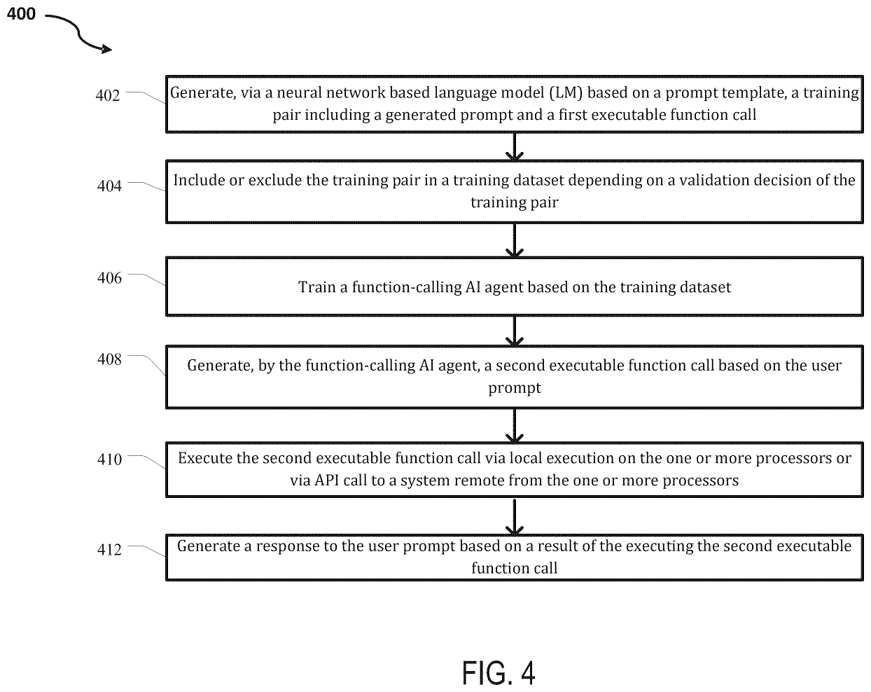

FIG. 4 is an example logic flow diagram illustrating a method of training a neural network based on the framework shown in FIGS. 1-3, according to some embodiments described herein. One or more of the processes of method 400 may be implemented, at least in part, in the form of executable code stored on non-transitory, tangible, machine-readable media that when run by one or more processors may cause the one or more processors to perform one or more of the processes. In some embodiments, method 400 corresponds to the operation of the function calling agent module 230 (e.g., FIGS. 2A and 3) that performs training of a function calling agent.

As illustrated, the method 400 includes a number of enumerated steps, but aspects of the method 400 may include additional steps before, after, and in between the enumerated steps. In some aspects, one or more of the enumerated steps may be omitted or performed in a different order.

In some embodiments, method 400 is performed by a system such as computing device 200, user device 310, server 330, or another device or combination of devices. Inputs (e.g., user queries) may be received via a data interface such as data interface 215, network interface 317, network interface 333, or via a data interface that is integrated with a device. For example UI Application 312 may receive user inputs via a text input interface (e.g., keyboard), audio input (e.g., microphone), video interface (e.g., camera), or other interface for receiving user inputs (e.g., a mouse or touch display).

At step 402, a system generates, via a neural network based LM (e.g., LLM 132) based on a prompt template (e.g., prompt template 122), a training pair including a generated prompt (e.g., query 136) and a first executable function call (e.g., function call answer 142). In some embodiments, generating the training pair includes sampling one or more function descriptions from a set of function descriptions (e.g., sampled from libraries 102). In some embodiments, generating the training pair includes sampling one or more query-function call pairs from a set of exemplary query-function call pairs (e.g., sampled from example datasets 104). In some embodiments, generating the training pair includes prompting the neural network based LM with a prompt including the sampled one or more function descriptions and the sampled one or more query-function call pairs. In some embodiments, generating the training pair includes sampling a prompt template text from a set of prompt template texts (e.g., prompts 120), and the prompt includes the sampled prompt template text. In some embodiments, the set of exemplary query-function call pairs includes at least one query-function call pair previously generated by the neural network based LM and validated (e.g., verified QA data 106).

At step 404, the system includes or excludes the training pair in a training dataset depending on a validation decision of the training pair (e.g., via multi-stage verification 112). In some embodiments, the decision to include or exclude the training pair may include checking, via one or more processors, a format of the first executable function call against a pre-defined format requirement (e.g., via format checker 138). checking the format includes verifying the first executable function call is a valid function call based on an application programming interface (API).

In some embodiments, the decision to include or exclude the training pair may include executing the first executable function call via local execution on the one or more processors or via API call to a system remote from the one or more processors, and validating a result of the executing the first executable function call (e.g., via execution checker 126). In some embodiments, executing the first executable function call includes executing using a sandbox environment. In some embodiments, validating a result of the executing the first executable function call includes prompting a second LM to validate the result based on the first executable function call and a result of the executing the first executable function call.

In some embodiments, the decision to include or exclude the training pair may include checking, via an LLM, whether the results semantically align with the query objective (e.g., via semantic checker 114). For example, a semantic checker 114 may send the query, functions, and execution results to an LLM 116 to check whether the results semantically align with the query objective.

At step 406, the system trains a function-calling AI agent based on the training dataset. In some embodiments, training is performed via backpropagation according to a loss function based on a comparison of generated outputs to known-good outputs (e.g., generated training pairs).

At step 408, the system generates, by the function-calling AI agent, a second executable function call based on a user prompt.

At step 410, the system executes the second executable function call via local execution on the one or more processors or via API call to a system remote from the one or more processors.

At step 412, the system generates a response to the user prompt based on a result of the executing the second executable function call. In some embodiments, the response is simply the output of execution. In some embodiments, the response it generated via an LLM using the output of execution as part of the prompt for the LLM.

In some embodiments, method 400 is applicable in a variety of applications. For example, the user prompt may relate to a diagnostic request in view of a medical record in a healthcare system, a curriculum designing request in an online education system, a code generation request in a software development system, a writing and/or editing request in a content generation system, an IT diagnostic request in an IT customer service support system, a navigation request in a robotic and autonomous system, and/or the like. By performing method 400, the neural network based artificial agent may improve technology in the respective technical field in healthcare and diagnostics, education and personalized learning, software development and code assistance, content creation, autonomous system (such as autonomous driving, etc.), and/or the like.

For example, when the user prompt includes a query to identify an information technology (IT) anomaly relating to a usage of an IT component such as a network gateway, a router, an online printer, and/or the like, by performing method 400 at an environment of a local area network (LAN), the neural network based artificial agent may receive an observation from the environment at which the next-step action is executed, and determine that the observation representing an information technology anomaly (e.g., a router failure, an unauthorized access attempt, a domain name system anomaly, and/or the like). In some implementations, the neural network based artificial agent may cause an alert relating to the information technology anomaly to be displayed at a visualized user interface. In this way, IT anomalies may be detected and alerted using the neural network based artificial agent in an efficient manner so as to improve network support technology.

In another example, the user prompt may include a request to perform an action such as purchasing something online. The trained function-calling AI agent may generate function calls, for example, that include API calls to a website to query the availability and other information relating to products for sale. The function-calling AI agent may in response to receiving the output of the API calls may generate an additional function for making a selection among multiple products (e.g., generate a python function that outputs the lowest priced item with a rating above a certain threshold). Based on the output of executing that function, the function-calling AI agent may perform further actions such as generating an additional API call to purchase the selected item. Other similar actions may be performed via such a trained function-calling AI agent. The breadth of types of functionalities that may be performed by the agent and the accuracy in performing them is improved via methods described herein.

In another example, the AI agent may be utilized in code generation. For example, the AI agent may be implemented within a software development environment. A user may interact with a user interface inputting code, or in some embodiments prompts relating to desired functionality of code. A user prompt (either entered directly or generated via other inputs from a user such as a partial line of code) may be input to the AI agent which may generate a function call. The function call may be output as recommended code to, for example, auto-complete a line of code typed by the user. In another embodiment, the generated code may be executed and the results may inform what the code should be recommended to the user. For example, an API call may be generated that requests information about the time zone in a particular city, and the result of that API call may be used to select a parameter value in generated code relating to time zones.

FIG. 5 illustrates exemplary data formats, according to some embodiments. API 502 and function call 504 illustrate exemplary JSON formats that may be used to store API and function call information respectively in library 102. For example, API 502 includes a name, description, and a parameters field that describes the available parameters for the API. Likewise, function call 504 includes a name and a field for arguments that indicates the arguments and may include data type information.

Generator output 506 represents an exemplary format imposed on outputs of LLM 132. The format may be indicated via the prompt to LLM 132 (e.g., as part of prompt template 122 or from a prompt sampled from prompts 120. The format may also be imposed via format checker 138 that rejects any function calls or queries not in the specified format. In the exemplary illustrated format, there is a query field indicating the generated query, and an “answers” field that may include one or more function calls or API calls.

The adoption of a standardized JSON format for APIs, function calls, and generator outputs provides several advantages. Firstly, it establishes a structural way to verify whether the generator's output contains all necessary fields. Outputs that fail to comply with these format requirements are discarded. Secondly, the JSON structure enables efficient checking of function calls for correct parsing and validity of arguments. Calls that include arguments not present in the API library or hallucinate non-existent functions are excluded, enhancing the overall quality of the dataset. Another key benefit is the scalability it enables. With this uniform format, systems performing methods described herein can easily incorporate data from diverse sources (Python functions, REST APIs, etc) by developing format converters that adapt them into these basic JSON elements, without modifying other core components, such as the prompting library, making the framework highly adaptable and extensible.

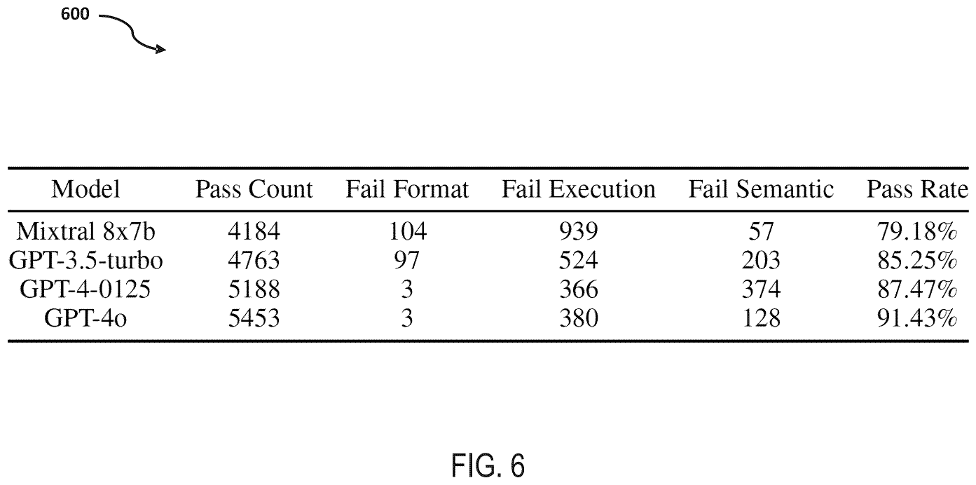

FIG. 6 is a chart illustrating performance results of embodiments described herein. The table illustrates statistics for the three stages of filtering using a number of different base LLMs for testing (Mixtral, GPT 3.5, GPT 4, and GPT 40). The filtering process (e.g., multi-stage verification 112) successfully removes many low-quality data points due to formatting issues, execution errors, or failure of the semantic check. Stronger models like GPT-4 have better format-following capability and higher pass rates, while Mixtral and GPT-3.5 have higher chances of producing data that cannot be executed. As illustrated, each step of verification is able to identify bad data that may be filtered out, leaving high quality data as the output.

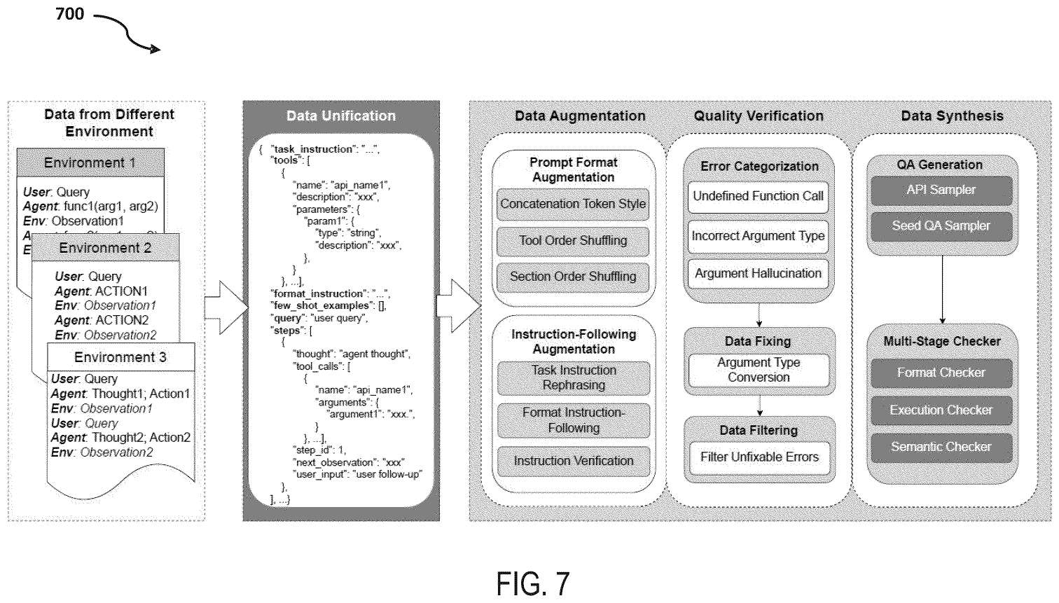

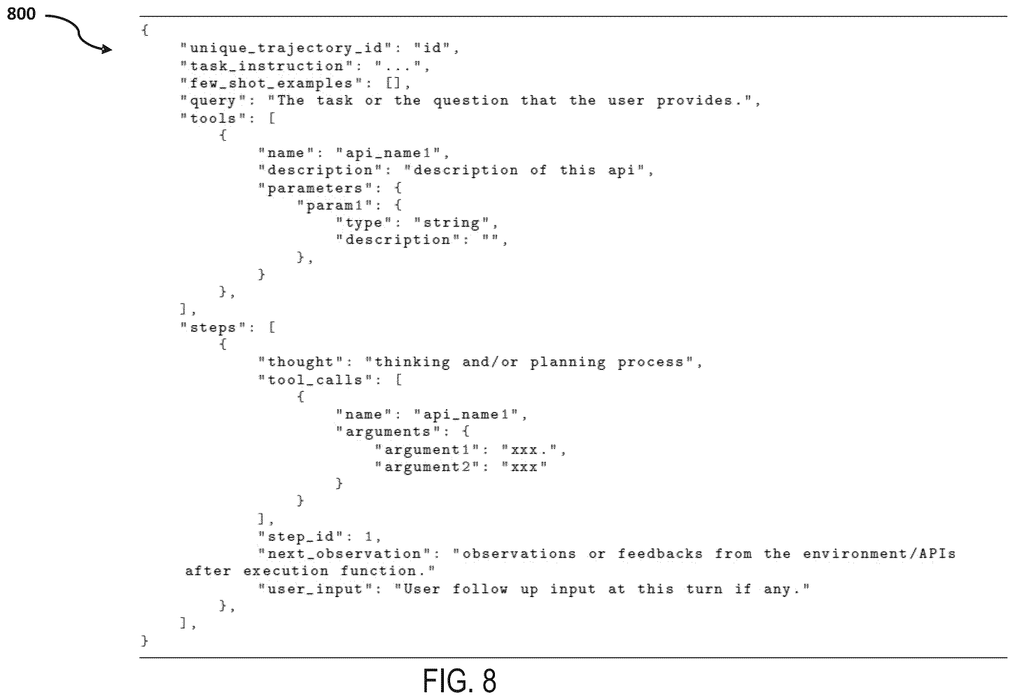

FIG. 7 illustrates a data generation pipeline, according to some embodiments. The data generation described herein in FIGS. 1-6 may be incorporated into a larger data pipeline. For example, the data synthesis stage of the illustrated data pipeline may include the generation of verified QA data 106 as described herein. This synthesized data may be combined with data from different environments, each of which may be converted into a unified data format (e.g., as described in FIG. 8) via a data unification process. All this data may further undergo data augmentation via a variety of methods to increase the amount of data and the diversity of the data. A quality verification step may be performed on all of this data including error categorization, data fixing, and data filtering. This data all together may be used in training a function-calling AI agent. For example, in method 400, the training of function-calling AI agent may be performed based on the training dataset (e.g., verified QA data 106), but may also be trained additionally based on data processed via the data pipeline illustrated in FIG. 7.

With regard to data unification, by standardizing the format of existing data, noise may be reduced, and easier data augmentation and quality verification may be facilitated, leading to a more efficient and robust framework for model training and evaluation. Furthermore, a standardized format ensures consistency, simplifies model training, and enhances the model's ability to generalize across various benchmarks. An exemplary unified function calling data format is illustrated and described in FIG. 8.

With regard to data augmentation, in some embodiments, the data augmentation strategy focuses on improving the diversity of the data. It involves applying various transformations to the existing dataset, thereby generating new, synthetic data samples. The data unification step significantly simplifies the application of various augmentation techniques. A standardized data format ensures consistency and ease of implementation, allowing for more efficient augmentation processes. Specifically, the augmentation techniques can be categorized as prompt format augmentation and instruction-following augmentation.

Prompt format augmentation focuses on creating various prompt formats based on the structured, unified data format. The format augmentation can be further divided into two categories: 1) Order Shuffling. In the unified format, the available tools are provided in a list, and each tool contains the name, description, and parameters. To avoid model overfitting to the specific order of the tools, the tool list may be randomly shuffled. Furthermore, the order of the name, description, parameters, and within the parameters may be shuffled to present the information in different ways. Shuffling may also be performed within the tool_calls in each step. Additionally, the order of different sections of the input, including task instruction, tools, format instruction, few-shot examples etc. may be shuffled. 2) Concatenation Tokens. Each training data point is a pair of input and output sequences. To convert the structured unified format to the training prompt, special tokens may be used to concatenate different sections into one sequence. For example, several different special token styles may be used, including “[START/END OF QUERY]”, “<query></query>”, and plain text.

Instruction-following augmentation focuses on adding diversity to the instructions in order to improve the model's instruction-following capability. It involves rephrasing existing instructions and adding new instructions, without introducing inaccuracy and inconsistency. Therefore, verification of the new instructions is a crucial step for this type of augmentation. Two methods may be used for instruction-following augmentation: 1) Task Instruction Rephrasing: rephrasing the task instructions using LLMs to accommodate various input styles from users. To ensure the rephrased instructions still align with the original version, they may be verified by prompting the LLMs with the rephrased instructions and check if the LLMs can still follow them and generate correct function calls. 2) Format Instruction-Following: In the unified format, the output format is a JSON string with thought and tool_calls. To avoid the model overfitting on JSON format and to enable the model to follow various output formats upon different format instructions, different output formats may be prepared along with their corresponding format instructions and format converters. The output formats include JSON, XML, YAML, plain text, etc.

With regard to data quality verification, verification may be performed, for example, looking for argument hallucination, undefined functions calls, or incorrect argument types. Models trained on data containing argument hallucinations are prone to generating hallucinated function calls. Therefore, detecting and filtering out trajectory data with this issue is crucial. To address this, an LLM may be utilized to perform step-wise argument hallucination detection, using a predetermined prompt. In function calling, a list of available functions is provided, and model should generate a function_call using one of the given functions. However, in many cases, the predicted function_call is not from the given list. The predicted function may be matched with the given functions by comparing the function names and the list of parameter names. When the function-call name does not match any given function, the system may consider it an undefined function. When the function name matches but the argument list contains undefined arguments, the system may consider it undefined arguments passed. Either scenario may cause for the function call to be rejected from the training dataset. Other than the error types mentioned above, sometimes the model generates the correct argument's value, but in the wrong types. For example, when a parameter expects a [val1, val2, val3], the generated arguments is “[val1, val2, val3]”, which is a string version of the list. When executing the function call, errors will occur due to incorrect data type. By comparing the parameter type in available tools and the argument type, trajectories may be identified containing the incorrect argument type error. In some embodiments, argument type errors may be corrected (rather than being outright rejected) by converting the arguments to the correct parameter types using ast.literal_eval( ), and this may correct many of the errors.

FIG. 8 illustrates an exemplary unified function calling data format, according to some embodiments. Function-calling formats form the basis for how models understand and execute tasks, motivating a unified data format in a function-calling style. As illustrated in FIG. 8, the unified format may consist of several modules: task instruction, available tools, format instruction, few-shot examples, query, and steps. Specifically, the available tools define the agent's action space, and the format instruction specifies the output format the agent should follow when generating a response. In each step, the agent's output, the environment's feedback/execution results, and the user's follow-up input are organized into a dictionary. It's quite common for there to be purely conversational interactions between users and agents that don't trigger any APIs or receive corresponding observations. In these instances, the related entry values would simply remain empty.

This unified format is compatible with various environments and tasks, making our data processing pipeline adaptable to different datasets and scalable to large amounts of data. Moreover, the modularized design allows for fine-grained data augmentation and quality verification, which are essential in improving agent data quality. For example, by unifying all the available tools and tool calls, a system can easily inspect for hallucination and function-call errors, and apply various augmentation techniques.

This description and the accompanying drawings that illustrate inventive aspects, embodiments, implementations, or applications should not be taken as limiting. Various mechanical, compositional, structural, electrical, and operational changes may be made without departing from the spirit and scope of this description and the claims. In some instances, well-known circuits, structures, or techniques have not been shown or described in detail in order not to obscure the embodiments of this disclosure. Like numbers in two or more figures represent the same or similar elements.

In this description, specific details are set forth describing some embodiments consistent with the present disclosure. Numerous specific details are set forth in order to provide a thorough understanding of the embodiments. It will be apparent, however, to one skilled in the art that some embodiments may be practiced without some or all of these specific details. The specific embodiments disclosed herein are meant to be illustrative but not limiting. One skilled in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

Although illustrative embodiments have been shown and described, a wide range of modification, change and substitution is contemplated in the foregoing disclosure and in some instances, some features of the embodiments may be employed without a corresponding use of other features. One of ordinary skill in the art would recognize many variations, alternatives, and modifications. Thus, the scope of the invention should be limited only by the following claims, and it is appropriate that the claims be construed broadly and, in a manner, consistent with the scope of the embodiments disclosed herein.

What is claimed is:

1. A method of generating, via one or more processors, a response to a user prompt by a function-calling artificial intelligence (AI) agent, the method comprising:
generating, via a neural network based language model (LM) based on a prompt template, a training pair including a generated prompt and a first executable function call;
including or excluding the training pair in a training dataset depending on a validation decision of the training pair, wherein the validation decision is made by at least one of:
checking, via the one or more processors, a format of the first executable function call against a pre-defined format requirement, or
executing the first executable function call via local execution on the one or more processors or via API call to a system remote from the one or more processors, and validating a result of the executing the first executable function call;
training the function-calling AI agent based on the training dataset;
generating, by the function-calling AI agent, a second executable function call based on the user prompt; and
executing the second executable function call via local execution on the one or more processors or via API call to a system remote from the one or more processors,
wherein the response to the user prompt is based on a result of the executing the second executable function call.

2. The method of claim 1, wherein the checking the format includes verifying the first executable function call is a valid function call based on an application programming interface (API).

3. The method of claim 1, wherein the executing the first executable function call includes executing using a sandbox environment.

4. The method of claim 1, wherein the validating a result of the executing the first executable function call includes prompting a second LM to validate the result based on the first executable function call and a result of the executing the first executable function call.

5. The method of claim 1, wherein generating the training pair includes:
sampling one or more function descriptions from a set of function descriptions;
sampling one or more query-function call pairs from a set of exemplary query-function call pairs; and
prompting the neural network based LM with a prompt including the sampled one or more function descriptions and the sampled one or more query-function call pairs.

6. The method of claim 5, wherein:
generating the training pair includes sampling a prompt template text from a set of prompt template texts, and
the prompt includes the sampled prompt template text.

7. The method of claim 5, wherein the set of exemplary query-function call pairs includes at least one query-function call pair previously generated by the neural network based LM and validated.

8. A system for generating a response to a user prompt by a function-calling artificial intelligence (AI) agent, the system comprising:
a memory that stores the function-calling AI agent and a plurality of processor executable instructions;
a communication interface that receives the user prompt; and
one or more hardware processors that read and execute the plurality of processor-executable instructions from the memory to perform operations comprising:
generating, via a neural network based language model (LM) based on a prompt template, a training pair including a generated prompt and a first executable function call;
including or excluding the training pair in a training dataset depending on a validation decision of the training pair, wherein the validation decision is made by at least one of:
checking, via the one or more processors, a format of the first executable function call against a pre-defined format requirement, or
executing the first executable function call via local execution on the one or more processors or via API call to a system remote from the one or more processors, and validating a result of the executing the first executable function call;
training the function-calling AI agent based on the training dataset;
generating, by the function-calling AI agent, a second executable function call based on the user prompt; and
executing the second executable function call via local execution on the one or more processors or via API call to a system remote from the one or more processors,
wherein the response to the user prompt is based on a result of the executing the second executable function call.

9. The system of claim 8, wherein the checking the format includes verifying the first executable function call is a valid function call based on an application programming interface (API).

10. The system of claim 8, wherein the executing the first executable function call includes executing using a sandbox environment.

11. The system of claim 8, wherein the validating a result of the executing the first executable function call includes prompting a second LM to validate the result based on the first executable function call and a result of the executing the first executable function call.

12. The system of claim 8, wherein generating the training pair includes:
sampling one or more function descriptions from a set of function descriptions;
sampling one or more query-function call pairs from a set of exemplary query-function call pairs; and
prompting the neural network based LM with a prompt including the sampled one or more function descriptions and the sampled one or more query-function call pairs.

13. The system of claim 12, wherein:
generating the training pair includes sampling a prompt template text from a set of prompt template texts, and
the prompt includes the sampled prompt template text.

14. The system of claim 12, wherein the set of exemplary query-function call pairs includes at least one query-function call pair previously generated by the neural network based LM and validated.

15. A non-transitory machine-readable medium comprising a plurality of machine-executable instructions which, when executed by one or more processors, are adapted to cause the one or more processors to perform operations comprising:
generating, via a neural network based language model (LM) based on a prompt template, a training pair including a generated prompt and a first executable function call;
including or excluding the training pair in a training dataset depending on a validation decision of the training pair, wherein the validation decision is made by at least one of:
checking, via the one or more processors, a format of the first executable function call against a pre-defined format requirement, or
executing the first executable function call via local execution on the one or more processors or via API call to a system remote from the one or more processors, and validating a result of the executing the first executable function call;
training a function-calling AI agent based on the training dataset;
generating, by the function-calling AI agent, a second executable function call based on a user prompt; and
executing the second executable function call via local execution on the one or more processors or via API call to a system remote from the one or more processors,
generating a response to the user prompt based on a result of the executing the second executable function call.

16. The non-transitory machine-readable medium of claim 15, wherein the checking the format includes verifying the first executable function call is a valid function call based on an application programming interface (API).

17. The non-transitory machine-readable medium of claim 15, wherein the executing the first executable function call includes executing using a sandbox environment.

18. The non-transitory machine-readable medium of claim 15, wherein the validating a result of the executing the first executable function call includes prompting a second LM to validate the result based on the first executable function call and a result of the executing the first executable function call.

19. The non-transitory machine-readable medium of claim 15, wherein generating the training pair includes:
sampling one or more function descriptions from a set of function descriptions;
sampling one or more query-function call pairs from a set of exemplary query-function call pairs; and
prompting the neural network based LM with a prompt including the sampled one or more function descriptions and the sampled one or more query-function call pairs.

20. The non-transitory machine-readable medium of claim 19, wherein:
generating the training pair includes sampling a prompt template text from a set of prompt template texts, and
the prompt includes the sampled prompt template text.
